(19) United States
(12) Patent Application Publication
(10) Pub. No.: US 2026/0143429 A1
(43) Pub. Date: May 21, 2026

(54) WAKE-UP SIGNAL CONFIGURATIONS IN WIRELESS COMMUNICATIONS

(71) Applicant: QUALCOMM Incorporated, San Diego, CA (US)

(72) Inventors: Jung Ho RYU, Englewood Cliffs, NJ (US); Jelena DAMNJANOVIC, Del Mar, CA (US); Igor GUTMAN, Hod HaSharon (IL); Tao LUO, San Diego, CA (US)

(21) Appl. No.: 19/362,103

(22) Filed: Oct. 17, 2025

Related U.S. Application Data
(60) Provisional application No. 63/721,392, filed on Nov. 15, 2024.

(51) Int. Cl. H04W 52/02; H04L 27/04; H04W 56/00

(52) U.S. Cl. CPC H04W 52/0235; H04W 52/0212; H04W 56/001; H04L 27/04

(57) ABSTRACT

Methods, systems, and devices for wireless communications are described in which a configuration of a wake-up signal (WUS), synchronization signal (SS), or both, may be selected based on one or more conditions at a user equipment (UE) that is to receive the signal. The configuration of the WUS, the SS, or both, may indicate a value (M) that corresponds to a quantity of bits per duration of time, such as per orthogonal frequency division multiplexing (OFDM) symbol duration. The configuration may also indicate whether an associated signal is transmitted with or without Manchester coding. In some implementations, a UE may transmit an indication of a requested or preferred configuration for a WUS or SS, and may be configured in accordance with the requested configuration.

### CROSS REFERENCES

The present Application for Patent claims benefit of U.S. Provisional Patent Application No. 63/721,392 by RYU et al., entitled “WAKE-UP SIGNAL CONFIGURATIONS IN WIRELESS COMMUNICATIONS,” filed Nov. 15, 2024, assigned to the assignee hereof, and expressly incorporated herein.

### FIELD OF TECHNOLOGY

The following relates to wireless communications, including wake-up signal configurations in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment is described. The method may include receiving configuration information for a wake-up signal that indicates a quantity of chips per orthogonal frequency division multiplexing (OFDM) symbol of the wake-up signal, where the wake-up signal uses on-off keying (OOK) modulation to indicate the user equipment (UE) is to transition from an idle state to an active state, receiving the wake-up signal using a first receiver in accordance with the configuration information, decoding control information from the wake-up signal based on the quantity of chips per OFDM symbol, and activating a second receiver based on the control information.

A user equipment for wireless communications is described. The user equipment may include one or more memories storing processor executable code, and one or more processors coupled with the one or more memories. The one or more processors may individually or collectively be operable to execute the code to cause the user equipment to receive configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state to an active state, receive the wake-up signal using a first receiver in accordance with the configuration information, decode control information from the wake-up signal based on the quantity of chips per OFDM symbol, and activate a second receiver based on the control information.

Another user equipment for wireless communications is described. The user equipment may include means for receiving configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state to an active state, means for receiving the wake-up signal using a first receiver in accordance with the configuration information, means for decoding control information from the wake-up signal based on the quantity of chips per OFDM symbol, and means for activating a second receiver based on the control information.

A non-transitory computer-readable medium storing code for wireless communications is described. The code may include instructions executable by one or more processors to receive configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state to an active state, receive the wake-up signal using a first receiver in accordance with the configuration information, decode control information from the wake-up signal based on the quantity of chips per OFDM symbol, and activate a second receiver based on the control information.

In some examples of the method, user equipment, and non-transitory computer-readable medium described herein, the configuration information further indicates whether the wake-up signal uses Manchester coding to encode at least a portion of the control information. Some examples of the method, user equipment, and non-transitory computer-readable medium described herein may further include operations, features, means, or instructions for transmitting an indication of a requested wake-up signal configuration to a network entity. In some examples of the method, user equipment, and non-transitory computer-readable medium described herein, the indication of the requested wake-up signal configuration includes a requested quantity of chips per OFDM symbol, a request for Manchester coding of the control information, a requested configuration of a set of multiple wake-up signal configurations, or any combination thereof.

In some examples of the method, user equipment, and non-transitory computer-readable medium described herein, the receiving configuration information may include operations, features, means, or instructions for receiving a set of multiple wake-up signal configurations that each indicate a corresponding quantity of chips per OFDM symbol, and that each indicate whether Manchester coding is used for the control information; and where the method further includes and receiving an indication that a first wake-up signal configuration of the set of multiple wake-up signal configurations is activated.

In some examples of the method, user equipment, and non-transitory computer-readable medium described herein, the indication that the first wake-up signal configuration of the set of multiple wake-up signal configurations is activated may be received in one or more control bits of the control information of the wake-up signal. In some examples of the method, user equipment, and non-transitory computer-readable medium described herein, the control information includes a first set of bits that indicate a target UE or UE group ID associated with the wake-up signal, and a second set of bits that indicate one or more parameters for activating the second receiver, and where a quantity of bits of the first set of bits or the second set of bits is based on the quantity of chips per OFDM symbol. In some examples of the method, user equipment, and non-transitory computer-readable medium described herein, the control information includes one or more of a wake-up or no-wake-up indication, an indication to transmit an uplink reference signal, an indication to transmit a measurement report, an indication to start or stop an inactivity timer, or any combination thereof.

In some examples of the method, user equipment, and non-transitory computer-readable medium described herein, a quantity of OOK symbols transmitted via the wake-up signal is based on the quantity of chips per OFDM symbol, or the quantity of chips per OFDM symbol is based on the quantity of OOK symbols transmitted via the wake-up signal. In some examples of the method, user equipment, and non-transitory computer-readable medium described herein, an OFDM sequence may be overlaid with on-duration chips of the wake-up signal, and the OFDM sequence may be selected based on the quantity of chips per OFDM symbol. In some examples of the method, user equipment, and non-transitory computer-readable medium described herein, the quantity of chips per OFDM symbol of the wake-up signal is different than a quantity of chips per OFDM symbol of a low-power synchronization signal that is transmitted by a network entity.

A method for wireless communications by a network entity is described. The method may include outputting, to a UE, configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state associated with activation of a first receiver at the UE to an active state associated with activation of a second receiver at the UE and outputting, to the UE, the wake-up signal in accordance with the configuration information, where the wake-up signal includes control information that is based on the quantity of chips per OFDM symbol.

A network entity for wireless communications is described. The network entity may include one or more memories storing processor executable code, and one or more processors coupled with the one or more memories. The one or more processors may individually or collectively be operable to execute the code to cause the network entity to output, to a UE, configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state associated with activation of a first receiver at the UE to an active state associated with activation of a second receiver at the UE and output, to the UE, the wake-up signal in accordance with the configuration information, where the wake-up signal includes control information that is based on the quantity of chips per OFDM symbol.

Another network entity for wireless communications is described. The network entity may include means for outputting, to a UE, configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state associated with activation of a first receiver at the UE to an active state associated with activation of a second receiver at the UE and means for outputting, to the UE, the wake-up signal in accordance with the configuration information, where the wake-up signal includes control information that is based on the quantity of chips per OFDM symbol.

A non-transitory computer-readable medium storing code for wireless communications is described. The code may include instructions executable by one or more processors to output, to a UE, configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state associated with activation of a first receiver at the UE to an active state associated with activation of a second receiver at the UE and output, to the UE, the wake-up signal in accordance with the configuration information, where the wake-up signal includes control information that is based on the quantity of chips per OFDM symbol.

In some examples of the method, network entities, and non-transitory computer-readable medium described herein, the configuration information further indicates whether the wake-up signal uses Manchester coding to encode at least a portion of the control information. Some examples of the method, network entities, and non-transitory computer-readable medium described herein may further include operations, features, means, or instructions for obtaining, from the UE, an indication of a requested wake-up signal configuration.

In some examples of the method, network entities, and non-transitory computer-readable medium described herein, the indication of the requested wake-up signal configuration includes a requested quantity of chips per OFDM symbol, a request for Manchester coding of the control information, a requested configuration of a set of multiple wake-up signal configurations, or any combination thereof.

In some examples of the method, network entities, and non-transitory computer-readable medium described herein, the outputting configuration information may include operations, features, means, or instructions for outputting a set of multiple wake-up signal configurations that each indicate a corresponding quantity of chips per OFDM symbol, and that each indicate whether Manchester coding is used for the control information; and where the method further includes and outputting an indication that a first wake-up signal configuration of the set of multiple wake-up signal configurations is activated.

In some examples of the method, network entities, and non-transitory computer-readable medium described herein, the indication that the first wake-up signal configuration of the set of multiple wake-up signal configurations is activated may be provided in one or more control bits of the control information of the wake-up signal. In some examples of the method, network entities, and non-transitory computer-readable medium described herein, the control information includes a first set of bits that indicate a target UE or UE group ID associated with the wake-up signal, and a second set of bits that indicate one or more parameters for activating the second receiver, and where a quantity of bits of the first set of bits or the second set of bits may be based on the quantity of chips per OFDM symbol. In some examples of the method, network entities, and non-transitory computer-readable medium described herein, the control information includes one or more of a wake-up or no-wake-up indication, an indication to transmit an uplink reference signal, an indication to transmit a measurement report, an indication to start or stop an inactivity timer, or any combination thereof.

In some examples of the method, network entities, and non-transitory computer-readable medium described herein, a quantity of OOK symbols transmitted via the wake-up signal is based on the quantity of chips per OFDM symbol, or the quantity of chips per OFDM symbol is based on the quantity of OOK symbols transmitted via the wake-up signal. In some examples of the method, network entities, and non-transitory computer-readable medium described herein, an OFDM sequence may be overlaid with on-duration chips of the wake-up signal, and the OFDM sequence may be selected based on the quantity of chips per OFDM symbol. In some examples of the method, network entities, and non-transitory computer-readable medium described herein, the quantity of chips per OFDM symbol of the wake-up signal is different than a quantity of chips per OFDM symbol of a low-power synchronization signal that is transmitted by a network entity.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports wake-up signal configurations in wireless communications in accordance with one or more aspects of the present disclosure.

FIG. 2 shows an example of a portion of a wireless communications system that supports wake-up signal configurations in wireless communications in accordance with one or more aspects of the present disclosure.

FIGS. 3 and 4 show examples of timing diagrams that support wake-up signal configurations in wireless communications in accordance with one or more aspects of the present disclosure.

FIG. 5 shows an example of a process flow that supports wake-up signal configurations in wireless communications in accordance with one or more aspects of the present disclosure.

FIGS. 6 and 7 show block diagrams of devices that support wake-up signal configurations in wireless communications in accordance with one or more aspects of the present disclosure.

FIG. 8 shows a block diagram of a communications manager that supports wake-up signal configurations in wireless communications in accordance with one or more aspects of the present disclosure.

FIG. 9 shows a diagram of a system including a device that supports wake-up signal configurations in wireless communications in accordance with one or more aspects of the present disclosure.

FIGS. 10 and 11 show block diagrams of devices that support wake-up signal configurations in wireless communications in accordance with one or more aspects of the present disclosure.

FIG. 12 shows a block diagram of a communications manager that supports wake-up signal configurations in wireless communications in accordance with one or more aspects of the present disclosure.

FIG. 13 shows a diagram of a system including a device that supports wake-up signal configurations in wireless communications in accordance with one or more aspects of the present disclosure.

FIGS. 14 through 17 show flowcharts illustrating methods that support wake-up signal configurations in wireless communications in accordance with one or more aspects of the present disclosure.

### DETAILED DESCRIPTION

Wireless networks may adopt various techniques and technologies to conserve power. One such example power saving technique may include use of a low-power wakeup radio (LP-WUR) at a user equipment (UE) that may be used in lieu of a main radio (MR) when the UE is in a lower power state, such as a sleep state. For example, the LP-WUR may be used to monitor for low-power wakeup signal (LP-WUS) transmissions, low-power synchronization signal (LP-SS) transmissions, or both. A LP-SS transmission may be transmitted periodically by a network entity and provide information for synchronization or timing of LP-SS and LP-WUS transmissions. A LP-WUS transmission may carry or otherwise convey an indication of whether the UE needs to transition to another state, such as a higher power state or an awake state, and power up the MR to perform wireless communications with a network. Such low-power (LP) signal transmissions may use on-off keying (OOK) modulation for low-complexity envelope detection by the LP-WUR. A LP-WUR may be a low-complexity and low power radio that can detect an OOK LP-WUS and then turn on other components of the UE (e.g., a MR and associated components) for subsequent communications.

In some cases, LP-WUS transmissions may target a coverage range that corresponds to a random access message range of a UE, and a LP-WUS range may be smaller than a physical downlink control channel (PDCCH) range because the LP-WUS may use a simpler waveform (e.g., an on-off keying (OOK) waveform) than a PDCCH orthogonal frequency division multiplexing (OFDM) waveform. In cases where a UE is in the LP-WUS range of a network entity, then the UE may achieve power savings through LP-WUS being enabled. In cases where the UE may be outside of the LP-WUS range of the network entity, the UE may be unable to use its LPR, and may instead use its MR, which can increase power consumption. Thus, it may be desirable to implement techniques in which a range of the LP-WUS may be adjusted based on a UE location within an area of potential coverage of a LP-WUS.

In accordance with various aspects discussed herein, a configuration of a LP-WUS, a LP-SS, or both, may be selected based on one or more conditions at a UE that is to receive the LP-WUS, LP-SS, or both. In some aspects, a configuration of a LP-WUS and LP-SS may indicate a value (M) that corresponds to a quantity of chips per OFDM symbol duration, may indicate whether the LP-WUS or LP-SS (or both) is transmitted with or without Manchester coding, or any combination thereof. A chip of an OFDM symbol duration may correspond to a one or more pulses during the OFDM symbol duration that represent a data bit of the signal. In some aspects, a network entity may transmit a LP-SS with M=1 (e.g., which may be a broadcast signal to multiple UEs), and may transmit a LP-WUS with M=4 (e.g., which is targeted for a specific UE). In some aspects, a UE may transmit an indication to the network entity of a requested or preferred configuration (or reconfiguration) for a LP-WUS. For example, a UE that is located a relatively far distance from the network entity may request a lower value of M, such that a range of the associated LP-WUS is increased, and a UE located closer to the network entity may request a higher value of M such that a higher quantity of data can be communicated via the LP-WUS. In some aspects, such a UE may indicate a preferred LP-WUS configuration that includes M (e.g., a quantity of bits per OFDM symbol duration), whether or not Manchester coding is requested, or any combination thereof. In some aspects, the network entity may configure a LP-WUS, a LP-SS, or both, based on the indication from the UE.

In some aspects, the configuration may include an indication of an overlaid OFDM sequence that used to generate LP-WUS. In some aspects, the network entity may provide multiple LP-WUS configurations, and activate one of the configurations for one or more subsequent LP-WUS transmissions. In some aspects, one or more control bits in LP-WUS may indicate activation or deactivation of a LP-WUS configuration. In some aspects, an allocation of a quantity of chips, or bits for indicating a target UE ID, or UE group ID, and a quantity of bits for control may depend on M. In some aspects, a quantity of OOK symbols for LP-WUS may depend on M, or M may depend on number of LP-WUS symbols. Further, in some cases, overlaid OFDM sequences used to generate the LP-WUS may depend on M. In some implementations, the network entity may transmit a LP-WUS, in accordance with the LP-WUS configuration, to a UE to trigger physical downlink control channel (PDCCH) monitoring at the UE.

Particular aspects of the subject matter described herein may be implemented to realize one or more potential advantages. The described techniques may provide for reduced processing, reduced power consumption, reduced latency, improved user experience related to reduced processing, more efficient utilization of communication resources, improved coordination between devices, and longer battery life. For example, the UE may reduce power consumption by receiving control information via a LP-WUS using a LP-WUR rather than having to receive such information via a separate PDCCH transmission from the LP-WUS. Additionally, or alternatively, the network entity may reduce power consumption by outputting fewer PDCCH transmissions relative to other techniques.

Aspects of the disclosure are initially described in the context of wireless communications systems. Aspects of the disclosure are further illustrated by and described with reference to timing diagrams, a process flow, apparatus diagrams, system diagrams, and flowcharts that relate to wake-up signal configurations in wireless communications.

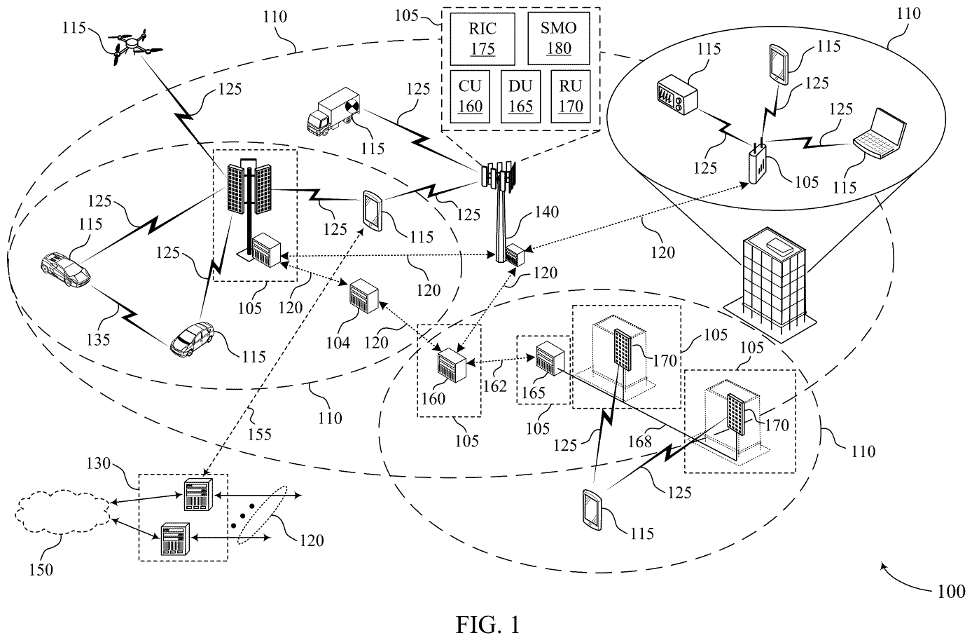

FIG. 1 shows an example of a wireless communications system 100 that supports wake-up signal configurations in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support wake-up signal configurations in wireless communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In accordance with various aspects discussed herein, one or more UEs 115 may operate in accordance with a low power state in which a LP-WUR may monitor for a WUS (e.g., a low power (LP)-WUS) during a low-power state of the UE 115, and transition the UE 115 to a higher power state upon detection of the LP-WUS. In some aspects, a configuration of a LP-WUS, a LP-SS, or both, may be selected based on one or more conditions at a UE 115 that is to receive the LP-WUS, LP-SS, or both. In some aspects, a configuration of a LP-WUS and LP-SS may indicate a value (M) that corresponds to a quantity of chips per OFDM symbol duration. Additionally, or alternatively, the configuration may indicate whether the LP-WUS or LP-SS (or both) is transmitted with or without Manchester coding. A chip of an OFDM symbol duration may correspond to a one or more pulses during the OFDM symbol that represent a data bit of the signal. In some aspects, a network entity 105 may transmit a LP-SS with M=1 (e.g., which may be a broadcast signal to multiple UEs), and may transmit a LP-WUS with M=4 (e.g., which is targeted for a specific UE). In some aspects, a UE 115 may transmit an indication to the network entity 105 of a requested or preferred configuration (or reconfiguration) for a LP-WUS.

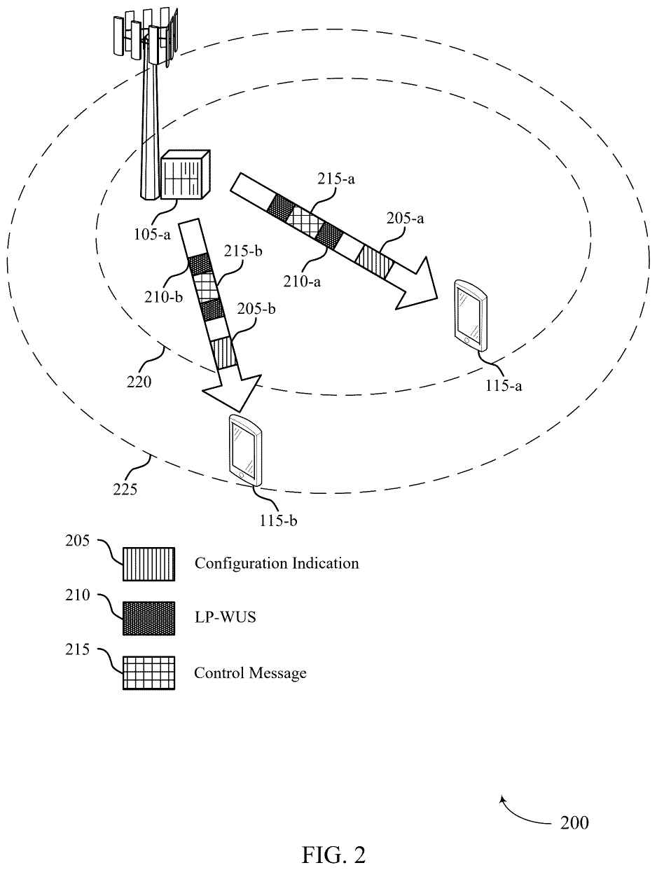

FIG. 2 shows an example of a wireless communications system 200 that supports wake-up signal configurations in wireless communications in accordance with one or more aspects of the present disclosure. In some examples, the wireless communications system 200 may implement aspects of the wireless communications system 100. For example, the wireless communications system 200 includes a first UE 115-a, a second UE 115-b, and a network entity 105-a, which may be examples of the corresponding devices described with reference to FIG. 1. Additionally, or alternatively, the UEs 115 and the network entity 105-a may each be examples of other types of wireless devices, such as an IAB node or another type of transmitter or receiver. Thus, although aspects of the present disclosure are described with reference to a UE 115-and a network entity 105, it is understood that the described techniques may be performed by a wireless device different from a UE 115-and a network entity 105. As described herein, operations performed by a UE 115-a and the network entity 105-a may be respectively performed by a UE 115, a network entity 105, or another wireless device, and the examples shown should not be construed as limiting.

In some examples, the network entity 105-a may output or transmit a wake-up signal, such as a LP-WUS 210, to one or more of the first UE 115-a or the second UE 115-b to trigger a transition from a lower power mode to a higher power mode. The LP-WUS 210 may provide a signaling design that allows for a relatively simple receiver architecture, and may be associated with a basic modulation scheme of OOK. That is, in this example, the first UE 115-a and the second UE 115-b may include at least two radios: a main radio (MR) and a low-power wake-up radio (LP-WUR) (e.g., a radio that provides for envelope detection of an OOK WUS). The LP-WUR may include relatively simplified receiver circuitry that may be used to monitor for and detect an LP-WUS 210. Since the LP-WUR may lack one or more other receiving capabilities and consume less power, the first UE 115-a and the second UE 115-b may save power by operating in a relatively low power state (e.g., a first power state) using the LP-WUR without operating more power-intensive circuitry including the MR.

As discussed herein, in some aspects, whether a LP-WUR may be used may depend on whether the LP-WUS 210 can be reliably received. For example, the first UE 115-a may be located relatively closer to the network entity 105-a and within a first coverage area 220 associated with a first LP-WUS 210 configuration. Further, the second UE 115-b may be located in a second coverage area 225 that is outside of the first coverage area 220, and not be able to reliably receive a LP-WUS 210 having the first configuration. In some aspects, instead of the second UE 115-b using its MR and relatively high power consumption (e.g., associated with a second power state) to increase receive functionality to monitor for downlink transmissions, such as PDCCH transmissions, the second UE 115-b may be configured with a second LP-WUS 210-b that has a different configuration than a first LP-WUS 210-a associated with the first UE 115-a.

Thus, in accordance with various aspects as discussed herein, the second UE 115-b may be able to implement lower-power operation based on a configuration of the second LP-WUS 210-b that is transmitted by the network entity 105-a. In some aspects, the network entity 105-a may transmit first configuration information 205-a to the first UE 115-a for the first LP-WUS 210-a, and may transmit second configuration information 205-b to the second UE 115-b for the second LP-WUS 210-b. In some aspects, the first LP-WUS 210-a may include a first control message 215-a and the second LP-WUS 210-b may include a second control message 215-b. In some aspects, the control messages 215 may be OFDM-based control channel signals (e.g., PDCCH signaling) that is overlaid on OOK-ON symbols of LP-WUSs 210, to provide for joint transmission of OFDM-based PDCCH and OOK LP-WUS. In some cases, within each OOK-ON symbol, an entire or partial PDCCH may transmitted, depending on the OOK symbol duration and number of information bits of the PDCCH. In some aspects, the network entity 105-a may also transmit a low power synchronization signal (LP-SS), which may be transmitted periodically, and on multiple beams. The LP-SS may allow UEs 115 in sleep mode to maintain time and frequency synchronization for the LP-WUS 210 transmissions.

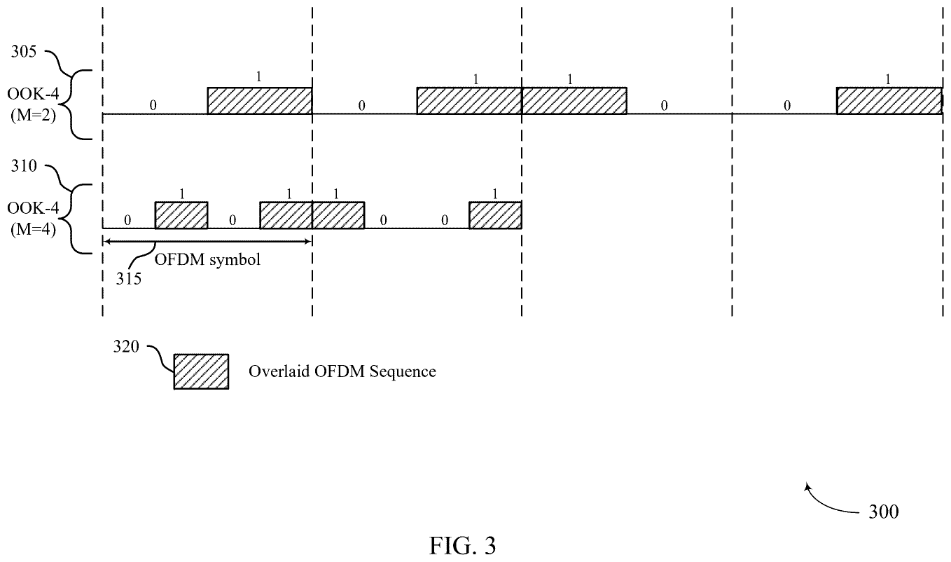

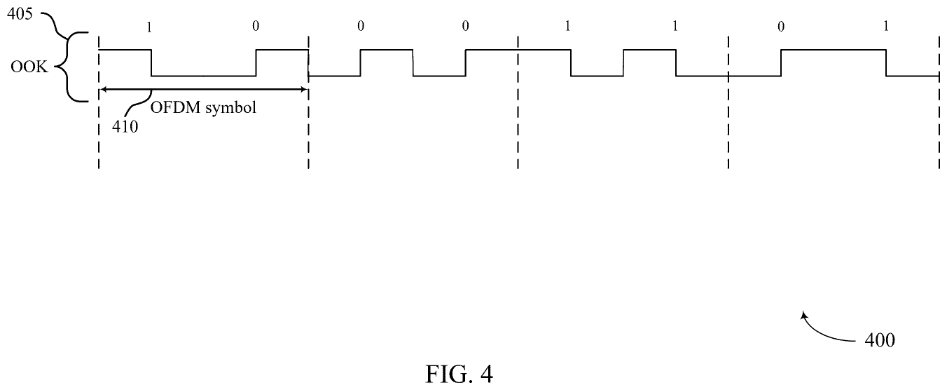

In some aspects, the LP-WUS 210, the LP-SS, or both, may be an OOK-1 and/or OOK-4 signal. An OOK waveform is a sequence of high power or high amplitude (or ON) durations or low (or zero) power or amplitude (or OFF) durations. An OOK-1 signal may convey one bit of information in one OFDM symbol (using the amplitude of the OOK-1 waveform), and an OOK-4 signal may convey M bits of information in one OFDM symbol (using amplitude(s) of the OOK-4 waveform). Additionally, in some implementations, Manchester coding may be used for indicating information bits of a LP-WUS 210 using a signal magnitude or power. In Manchester coding, a bit value of one may be indicated using high-to-low signal (or low-to-high), and a bit value of zero may be indicated using low-to-high signal (or high-to-low). FIGS. 3 and 4 illustrate examples of OOK signaling for a LP-WUS 210, and Manchester coding that may be used for a LP-WUS 210, respectively.

As discussed herein, in some implementations a target coverage range of a LP-WUS 210 may correspond to an uplink signal (e.g., a MSG3 random access message), and a range of a LP-WUS 210 may be smaller than corresponding PDCCH range due to the OOK waveform of the LP-WUS 210. As also discussed herein, if a UE 115 is within a LP-WUS 210 range, then the UE 115 may benefit from power savings by enabling LP-WUS 210 receptions using a LP-WUR and reducing power for the MR. In some aspects, the network entity 105-a may be aware of whether a UE 115 is in LP-WUS 210 range to enable LP-WUS-based operation. In some aspects, the network entity 105-a may enable LP-WUS 210 triggered PDCCH monitoring for each UE 115 based on one or more measurement reports (e.g., a channel state information (CSI) report) from each UE 115, or an explicit indication from a UE 115 that it is in range of the LP-WUS 210. Further, in cases where the network entity 105-a is aware of UEs 115 that are within or outside of the LP-WUS 210 range, the network entity 105-a may allocate appropriate resources for LP-WUS 210 transmission, or may use such resources for other purposes. Further, in some aspects the LP-WUS 210 transmissions may be based on either a bitmap or a codepoint that is indicated in the signal. For bitmap based signals, a bit of the bitmap (e.g., bit ‘i’ of the bitmap) of LP-WUS 210 indicates UE(s) associated with bit i to wake up or not wake up. In some implementations, a bitmap based LP-WUS 210 may contain a cyclic redundancy check (CRC), so that UEs 115 can check the LP-WUS 210 was received correctly or not. For a codepoint based LP-WUS 210, the UEs 115 may monitor for a sequence of bits in allocated time and frequency resources of the LP-WUS 210 to wake up, and if the sequence is not present, UE 115 does not wake up.

As indicated herein, in various aspects the LP-WUS 210 may have a different configuration based on whether the associated UE 115 is within the first coverage area 220 or the second coverage area 225. As discussed, the second UE 115-b may be closer to a cell edge of the network entity 105-a, and a lower quantity of chips per ODFM symbol (e.g., M=1) may provide better reliability and likelihood of successful reception of the second LP-WUS 210-b; and the first UE 115-a may be closer to a cell center of the network entity 105-a, and a higher quantity of chips per ODFM symbol (e.g., M=4) may provide for additional information bits to be communicated while also providing sufficient reliability and likelihood of successful reception of the first LP-WUS 210-a. In some implementations, the first configuration information 205-a may configure the first LP-WUS 210-a (and/or an associated LP-SS) with a first value of M, that indicates the number of chips per OFDM symbol duration, an indication of whether or not the first LP-WUS 210-a uses Manchester coding, or both. Similarly, the second configuration information 205-b may configure the second LP-WUS 210-b (and/or an associated LP-SS) with a second value of M, that indicates the number of chips per OFDM symbol duration, an indication of whether or not the second LP-WUS 210-b uses Manchester coding, or both. Further, in some implementations the network entity 105-a may transmit LP-SS with M=1 (e.g., as a broadcast transmission to multiple UEs 115), may transmit the first LP-WUS 210-a with M=4 for the first UE 115-a, and may transmit the second LP-WUS 210-b with M=1 for the second UE 115-b.

In some implementations, each of the first UE 115-a and the second UE 115-b may transmit an indication or request to the network entity 105-a of a preferred LP-WUS 210 configuration (e.g., as part of an initial configuration or as part of a reconfiguration). In some aspects, the indication or request transmitted to the network entity 105-a may include an indication of a requested or preferred value of M, the number of bits per OOK symbol, whether or not Manchester coding is requested, or any combination thereof. In some implementations, each configuration information 205 may include an indication of the value of M, bits per OOK symbol, whether or not Manchester coding is enabled, or any combination thereof. In some implementations, the requested or preferred configuration information may also indicate which of multiple available overlaid OFDM sequences is used to generate the corresponding LP-WUS 210. In some aspects, a transmission of the UE 115 preference information may be triggered by a request from the network entity 105 to indicate a preference or request for LP-WUS 210 configuration. In some implementations, the network entity 105-a may provide multiple LP-WUS configurations, and activate one of the configurations (e.g., based on a request from a UE 115, based on one or more CSI reports from a UE 115, etc.). In some implementations, one or more of the control bits in LP-WUS 210 may indicate an activation or deactivation of a LP-WUS configuration.

In some aspects, an allocation of a quantity of bits (or chips) for indicating a target UE 115 (e.g., based on an identifier associated with the UE 115) or a UE group ID (e.g., an identifier that is associated with two or more UEs 115), and number of bits for control, may depend on the quantity of chips (e.g., M) configured for the LP-WUS configuration. One or more control bits indicated by the LP-WUS may include one or more of control bits for a wake-up or no-wake-up indication, an indication to transmit a reference signals or measurement report (e.g., to transmit a sounding reference signal (SRS) or a CSI report), an indication to start or stop an inactivity timer, or any combination thereof. For example, the network entity 105-a may allocate 16 symbols for LP-WUS 210. In such examples, for M=1, there are 16 bits in LP-WUS 210. Out of the 16 bits, eight bits may be allocated for indicating a target UE identification, and the other 8 bits may be used for control. Continuing with this example, for M=2, eight bits may be allocated for a target UE ID indication, and 24 bits may be allocated for control. In some aspects, a quantity of OOK symbols for LP-WUS 210 may depend on M, or M may depend on a quantity of OOK symbols of the LP-WUS 210, Additionally, or alternatively, one or more overlaid OFDM sequences used to generate a LP-WUS 210 may depend on M.

FIG. 3 shows an example of a timing diagram 300 that supports wake-up signal configurations in wireless communications in accordance with one or more aspects of the present disclosure. The timing diagram 300 may implement or be implemented by one or more aspects of the wireless communications system 100 and the wireless communications system 200 described with reference to FIGS. 1 and 2, respectively. For example, the timing diagram 300 may be implemented by a network entity 105 and a UE 115 as described with reference to FIGS. 1 and 2 to support reduced power consumption through implementation of a LP-WUS.

For example, the timing diagram 300 illustrates a first OOK signal 305, that is a OOK-4 signal with M=2 (that is, there are two chips per OFDM symbol 315 duration). In this example, the first OOK signal 305 may transmit the bit sequence ‘01011001’ over four OFDM symbols 315. The timing diagram 300 also illustrates a second OOK signal 310, that is a OOK-4 signal with M=4 (that is, there are four chips per OFDM symbol 315 duration). In this example, the second OOK signal 310 may transmit the bit sequence ‘01011001’ over two OFDM symbols 315. In the timing diagram 300, the ‘ON’ portions of the OFDM symbols 315 may include an overlaid OFDM sequence 320, which in some implementations may also be used to convey control information via the LP-WUS. Thus, in some aspects, the first OOK signal 305 and/or the second OOK signal 310 may carry wakeup information and control information via overlaid OFDM sequence 320. The control information may include, for example, a paging PDCCH or paging early indication (PEI) for idle and inactive modes.

FIG. 4 shows an example of a timing diagram 400 that supports wake-up signal configurations in wireless communications in accordance with one or more aspects of the present disclosure. The timing diagram 400 may implement or be implemented by one or more aspects of the wireless communications system 100 and the wireless communications system 200 described with reference to FIGS. 1 and 2, respectively, or the timing diagram 300 of FIG. 3. For example, the timing diagram 400 may be implemented by a network entity 105 and a UE 115 as described with reference to FIGS. 1 and 2 to support reduced power consumption through implementation of a LP-WUS.

In the example of FIG. 4, an OOK signal 405 (e.g., with M=4) in which Manchester coding is used for the OOK signal 405. In this example, for M=4, each OFDM symbol 410 duration may include two Manchester coded bits, and a transition from an OOK ON chip to an OOK OFF chip may indicate a value of ‘1’ with a transition from an OOK OFF chip to an OOK ON chip indicating a value of ‘0.’ Thus, in this example, the bit sequence ‘10001101’ may be transmitted using four OFDM symbols 410.

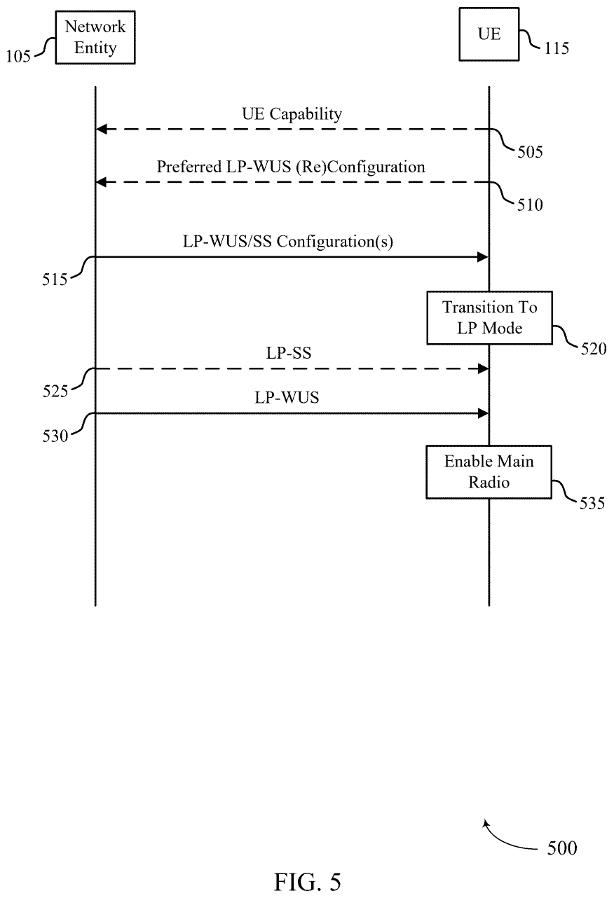

FIG. 5 shows an example of a process flow 500 that supports wake-up signal configurations in wireless communications in accordance with one or more aspects of the present disclosure. The process flow 500 may implement or be implemented to realize one or more aspects of the wireless communications system 100 and the wireless communications system 200 described with reference to FIGS. 1 and 2, timing diagram 300 described with reference to FIG. 3, or the timing diagram 400 described with reference to FIG. 4. For example, the process flow 500 illustrates communication between a UE 115 and a network entity 105, which may be examples of corresponding devices as illustrated and described herein, including by or with reference to FIG. 1-4.

In the following description of the process flow 500, the operations may be performed (e.g., reported or provided) in a different order than the order shown, or the operations performed by the example devices may be performed in different orders or at different times. Some operations also may be left out of the process flow 500, or other operations may be added to the process flow 500. Further, although some operations or signaling may be shown to occur at different times for discussion purposes, these operations may actually occur at the same time.

At 505, the UE 115 optionally may transmit, and the network entity 105 may receive, information indicative of a capability of the UE 115. For example, the UE 115 may transmit an indication of a capability for LP-WUS based transitions between lower power and higher power states. In some implementations, the capability indication may also indicate a UE 115 capability to request or indicate a preferred configuration for LP-WUS related transmissions, as discussed herein.

At 510, the UE 115 optionally may transmit, and the network entity 105 may receive, a preferred LP-WUS configuration (or reconfiguration). In some implementations, the preferred LP-WUS configuration may indicate a value for M that is requested by the UE 115. In some implementations, the determination of the value for M may be based on one or more reference signals transmitted by the network entity 105 and measured at the UE 115, where a measured reference signal receive power (RSRP) at the UE 115 may be compared against one or more threshold values associated with different values for M. For example, a RSRP value below a first threshold value may be associated with M=1 that may allow for longer range LP-WUS transmissions, and a RSRP value at or above the first threshold value may be associated with M=2 (or M=4) that may allow for shorter range LP-WUS transmissions that are able to carry more data bits relative to LP-WUS transmissions with M=1. In other examples, two or more threshold values may be configured that are configured with three or more values of M.

At 515, the network entity 105 may transmit, and the UE 115 may receive, information indicative of one or more LP-WUS and/or LP-SS configurations. In some implementations, the configuration information may provide an indication of a value of M for LP-WUS transmissions from the network entity 105, in accordance with techniques as discussed herein. In some examples, multiple different configurations may be provided to the UE 115, and one of the configurations may be enabled by the network entity 105 (e.g., based on an indication of an index value associated with the enabled configuration).

At 520, the UE 115 may determine to transition to a low-power (LP) mode. In some implementations, such a determination may be made based on the network entity 105 enabling a LP-WUS. Additionally, or alternatively, such a determination may be made at the UE 115 based on communications traffic between the UE 115 and network entity 105. The UE 115 may transition to the LP mode, and monitor for a LP-WUS, in accordance with techniques as discussed herein.

At 525, the network entity 105 optionally may transmit, and the UE 115 may receive, one or more LP-SS signals. The LP-SS signals may be used by the UE 115 to maintain synchronization and monitor for LP-WUS transmissions. At 530, the network entity 105 may transmit, and the UE 115 may receive, one or more LP-WUS signals. The one or more LP-WUS signals may be transmitted in accordance with the LP-WUS configuration, in accordance with techniques as discussed herein. At 535, the UE 115 may transition to a higher-power state and enable the MR, based on an indication in the LP-WUS that the UE 115 is to transition to the higher-power state. In some implementations, the LP-WUS may include control information that includes an identifier associated with the UE 115 and indicates the UE 115 is to turn on its MR, and in cases where the control information does not include the identifier associated with the UE 115, the LP state may be maintained at the UE 115 (and the UE 115 may continue to monitor for LP-WUS transmissions using the LP-WUR).

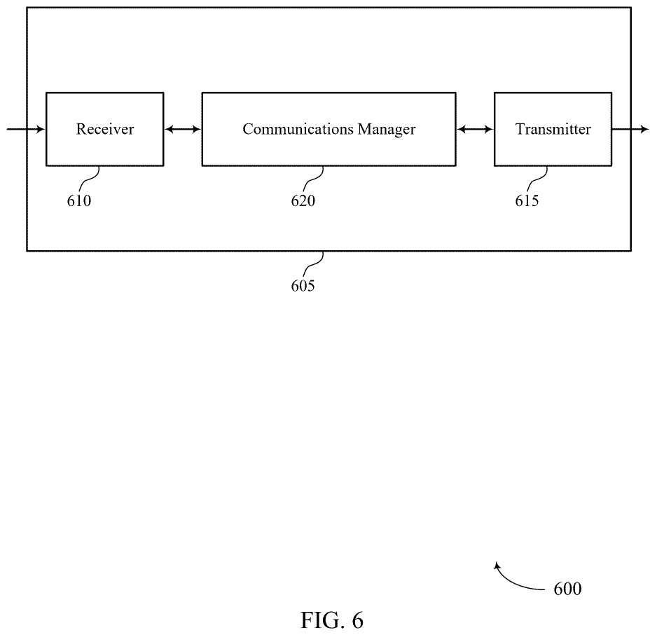

FIG. 6 shows a block diagram 600 of a device 605 that supports wake-up signal configurations in wireless communications in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to wake-up signal configurations in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to wake-up signal configurations in wireless communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of wake-up signal configurations in wireless communications as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both, to obtain information, output information, or perform various other operations as described herein.

The communications manager 620 may support wireless communications in accordance with examples as disclosed herein. For example, the communications manager 620 is capable of, configured to, or operable to support a means for receiving configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state to an active state. The communications manager 620 is capable of, configured to, or operable to support a means for receiving the wake-up signal using a first receiver in accordance with the configuration information. The communications manager 620 is capable of, configured to, or operable to support a means for decoding control information from the wake-up signal based on the quantity of chips per OFDM symbol. The communications manager 620 is capable of, configured to, or operable to support a means for activating a second receiver based on the control information.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for wake-up signal configurations that provide for reduced processing, reduced power consumption, and more efficient utilization of communication resources.

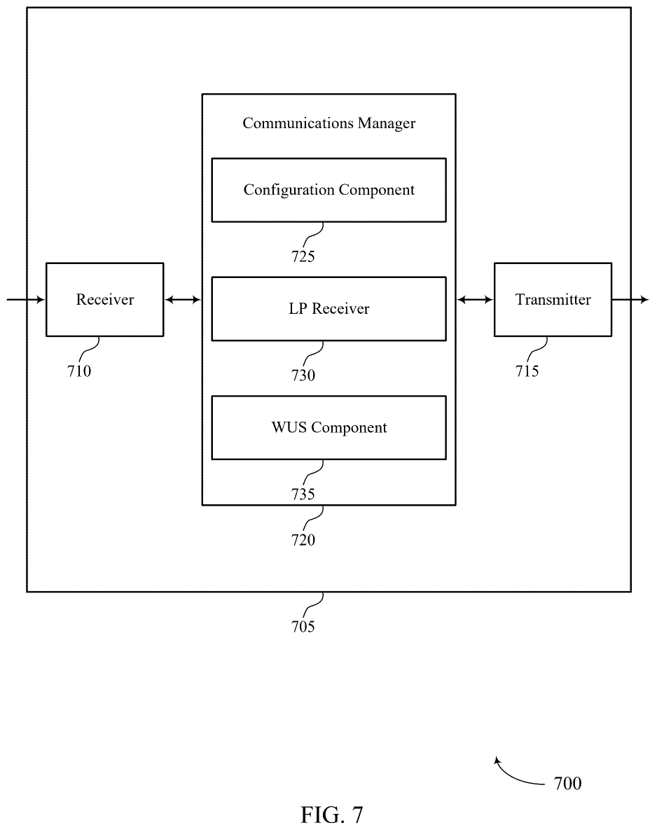

FIG. 7 shows a block diagram 700 of a device 705 that supports wake-up signal configurations in wireless communications in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to wake-up signal configurations in wireless communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to wake-up signal configurations in wireless communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of wake-up signal configurations in wireless communications as described herein. For example, the communications manager 720 may include a configuration component 725, an LP receiver 730, a WUS component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The configuration component 725 is capable of, configured to, or operable to support a means for receiving configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state to an active state. The LP receiver 730 is capable of, configured to, or operable to support a means for receiving the wake-up signal using a first receiver in accordance with the configuration information. The WUS component 735 is capable of, configured to, or operable to support a means for decoding control information from the wake-up signal based on the quantity of chips per OFDM symbol. The WUS component 735 is capable of, configured to, or operable to support a means for activating a second receiver based on the control information.

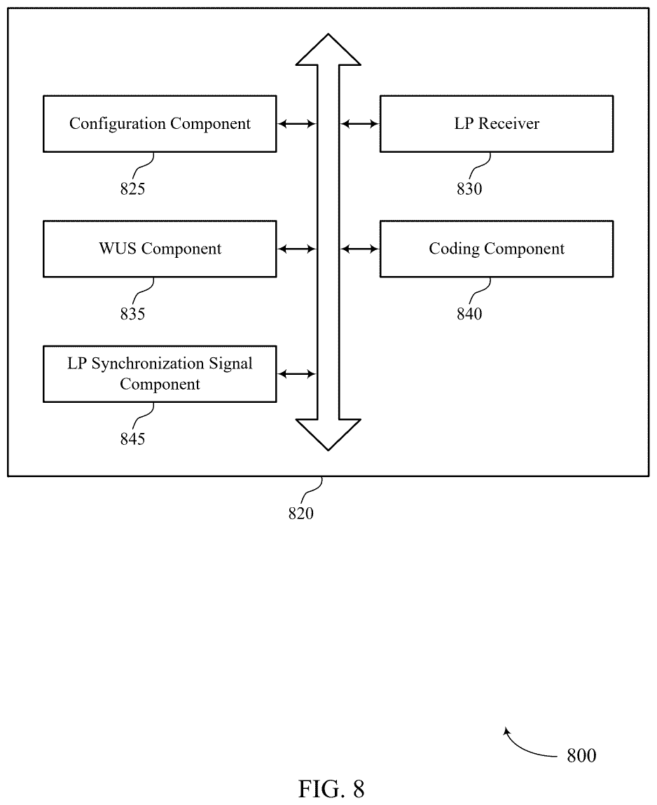

FIG. 8 shows a block diagram 800 of a communications manager 820 that supports wake-up signal configurations in wireless communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of wake-up signal configurations in wireless communications as described herein. For example, the communications manager 820 may include a configuration component 825, an LP receiver 830, a WUS component 835, a coding component 840, an LP synchronization signal component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The configuration component 825 is capable of, configured to, or operable to support a means for receiving configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state to an active state. The LP receiver 830 is capable of, configured to, or operable to support a means for receiving the wake-up signal using a first receiver in accordance with the configuration information. The WUS component 835 is capable of, configured to, or operable to support a means for decoding control information from the wake-up signal based on the quantity of chips per OFDM symbol. In some examples, the WUS component 835 is capable of, configured to, or operable to support a means for activating a second receiver based on the control information. In some examples, the configuration information further indicates whether the wake-up signal uses Manchester coding to encode at least a portion of the control information.

In some examples, the configuration component 825 is capable of, configured to, or operable to support a means for transmitting an indication of a requested wake-up signal configuration to a network entity. In some examples, the indication of the requested wake-up signal configuration includes a requested quantity of chips per OFDM symbol, a request for Manchester coding of the control information, a requested configuration of a set of multiple wake-up signal configurations, or any combination thereof.

In some examples, to support receiving configuration information, the configuration component 825 is capable of, configured to, or operable to support a means for receiving a set of multiple wake-up signal configurations that each indicate a corresponding quantity of chips per OFDM symbol, and that each indicate whether Manchester coding is used for the control information; and where the method further includes. In some examples, to support receiving configuration information, the configuration component 825 is capable of, configured to, or operable to support a means for receiving an indication that a first wake-up signal configuration of the set of multiple wake-up signal configurations is activated.

In some examples, the indication that the first wake-up signal configuration of the set of multiple wake-up signal configurations is activated is received in one or more control bits of the control information of the wake-up signal. In some examples, the control information includes a first set of bits that indicate a target UE or UE group ID associated with the wake-up signal, and a second set of bits that indicate one or more parameters for activating the second receiver, and where a quantity of bits of the first set of bits or the second set of bits is based on the quantity of chips per OFDM symbol.

In some examples, the control information includes one or more of a wake-up or no-wake-up indication, an indication to transmit an uplink reference signal, an indication to transmit a measurement report, an indication to start or stop an inactivity timer, or any combination thereof. In some examples, a quantity of OOK symbols transmitted via the wake-up signal is based on the quantity of chips per OFDM symbol, or the quantity of chips per OFDM symbol is based on the quantity of OOK symbols transmitted via the wake-up signal.

In some examples, an OFDM sequence is overlaid with on-duration chips of the wake-up signal, and the OFDM sequence is selected based on the quantity of chips per OFDM symbol. In some examples, the quantity of chips per OFDM symbol of the wake-up signal is different than a quantity of chips per OFDM symbol of a low-power synchronization signal that is transmitted by a network entity.

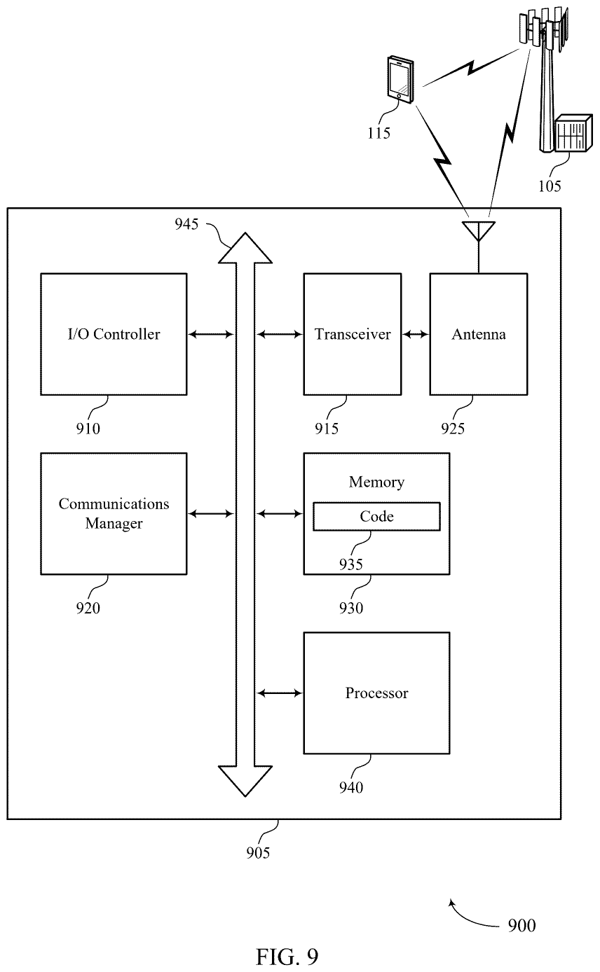

FIG. 9 shows a diagram of a system 900 including a device 905 that supports wake-up signal configurations in wireless communications in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting wake-up signal configurations in wireless communications). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state to an active state. The communications manager 920 is capable of, configured to, or operable to support a means for receiving the wake-up signal using a first receiver in accordance with the configuration information. The communications manager 920 is capable of, configured to, or operable to support a means for decoding control information from the wake-up signal based on the quantity of chips per OFDM symbol. The communications manager 920 is capable of, configured to, or operable to support a means for activating a second receiver based on the control information.

By including or configuring the communications manager 920 in accordance with examples as described herein, the device 905 may support techniques for wake-up signal configurations that provide for reduced latency, improved user experience related to reduced processing, reduced power consumption, more efficient utilization of communication resources, improved coordination between devices, and longer battery life.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of wake-up signal configurations in wireless communications as described herein, or the at least one processor 940 and the at least one memory 930 may be otherwise configured to, individually or collectively, perform or support such operations.

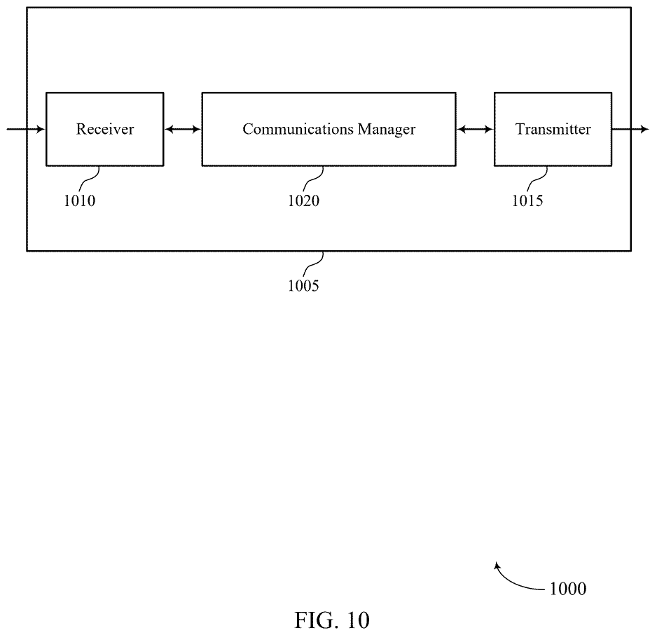

FIG. 10 shows a block diagram 1000 of a device 1005 that supports wake-up signal configurations in wireless communications in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of wake-up signal configurations in wireless communications as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting, to a UE, configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state associated with activation of a first receiver at the UE to an active state associated with activation of a second receiver at the UE. The communications manager 1020 is capable of, configured to, or operable to support a means for outputting, to the UE, the wake-up signal in accordance with the configuration information, where the wake-up signal includes control information that is based on the quantity of chips per OFDM symbol.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for wake-up signal configurations that provide for reduced processing, reduced power consumption, and more efficient utilization of communication resources.

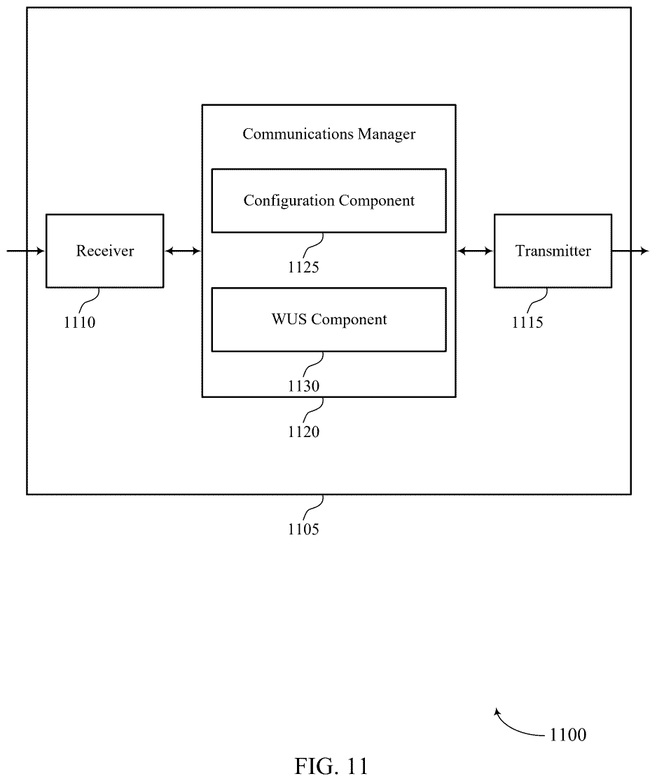

FIG. 11 shows a block diagram 1100 of a device 1105 that supports wake-up signal configurations in wireless communications in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of wake-up signal configurations in wireless communications as described herein. For example, the communications manager 1120 may include a configuration component 1125, a WUS component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The configuration component 1125 is capable of, configured to, or operable to support a means for outputting, to a UE, configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state associated with activation of a first receiver at the UE to an active state associated with activation of a second receiver at the UE. The WUS component 1130 is capable of, configured to, or operable to support a means for outputting, to the UE, the wake-up signal in accordance with the configuration information, where the wake-up signal includes control information that is based on the quantity of chips per OFDM symbol.

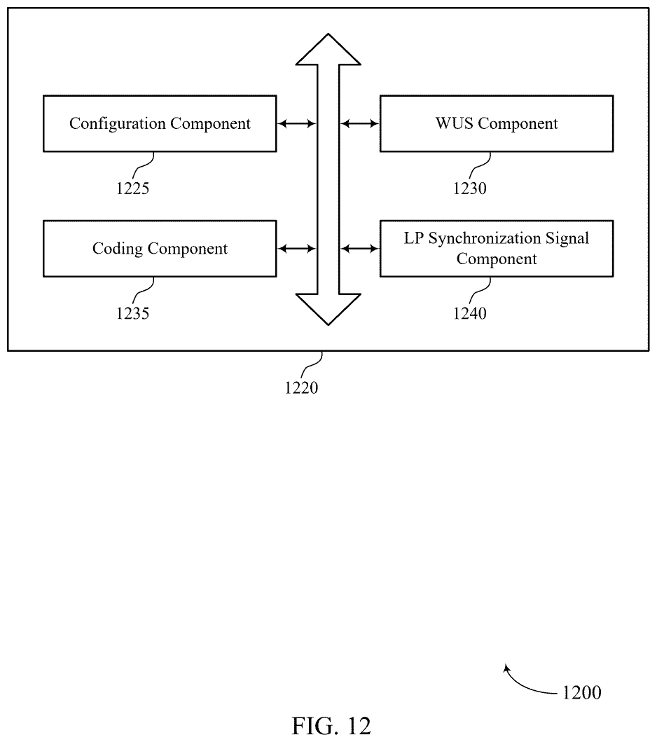

FIG. 12 shows a block diagram 1200 of a communications manager 1220 that supports wake-up signal configurations in wireless communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of wake-up signal configurations in wireless communications as described herein. For example, the communications manager 1220 may include a configuration component 1225, a WUS component 1230, a coding component 1235, an LP synchronization signal component 1240, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The configuration component 1225 is capable of, configured to, or operable to support a means for outputting, to a UE, configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state associated with activation of a first receiver at the UE to an active state associated with activation of a second receiver at the UE. The WUS component 1230 is capable of, configured to, or operable to support a means for outputting, to the UE, the wake-up signal in accordance with the configuration information, where the wake-up signal includes control information that is based on the quantity of chips per OFDM symbol. In some examples, the configuration information further indicates whether the wake-up signal uses Manchester coding to encode at least a portion of the control information.

In some examples, the configuration component 1225 is capable of, configured to, or operable to support a means for obtaining, from the UE, an indication of a requested wake-up signal configuration. In some examples, the indication of the requested wake-up signal configuration includes a requested quantity of chips per OFDM symbol, a request for Manchester coding of the control information, a requested configuration of a set of multiple wake-up signal configurations, or any combination thereof.

In some examples, to support outputting configuration information, the configuration component 1225 is capable of, configured to, or operable to support a means for outputting a set of multiple wake-up signal configurations that each indicate a corresponding quantity of chips per OFDM symbol, and that each indicate whether Manchester coding is used for the control information; and where the method further includes. In some examples, to support outputting configuration information, the configuration component 1225 is capable of, configured to, or operable to support a means for outputting an indication that a first wake-up signal configuration of the set of multiple wake-up signal configurations is activated.

In some examples, the indication that the first wake-up signal configuration of the set of multiple wake-up signal configurations is activated is provided in one or more control bits of the control information of the wake-up signal. In some examples, the control information includes a first set of bits that indicate a target UE or UE group ID associated with the wake-up signal, and a second set of bits that indicate one or more parameters for activating the second receiver, and where a quantity of bits of the first set of bits or the second set of bits is based on the quantity of chips per OFDM symbol.

In some examples, the control information includes one or more of a wake-up or no-wake-up indication, an indication to transmit an uplink reference signal, an indication to transmit a measurement report, an indication to start or stop an inactivity timer, or any combination thereof.

In some examples, a quantity of OOK symbols transmitted via the wake-up signal is based on the quantity of chips per OFDM symbol, or the quantity of chips per OFDM symbol is based on the quantity of OOK symbols transmitted via the wake-up signal. In some examples, an OFDM sequence is overlaid with on-duration chips of the wake-up signal, and the OFDM sequence is selected based on the quantity of chips per OFDM symbol. In some examples, the quantity of chips per OFDM symbol of the wake-up signal is different than a quantity of chips per OFDM symbol of a low-power synchronization signal that is transmitted by a network entity.

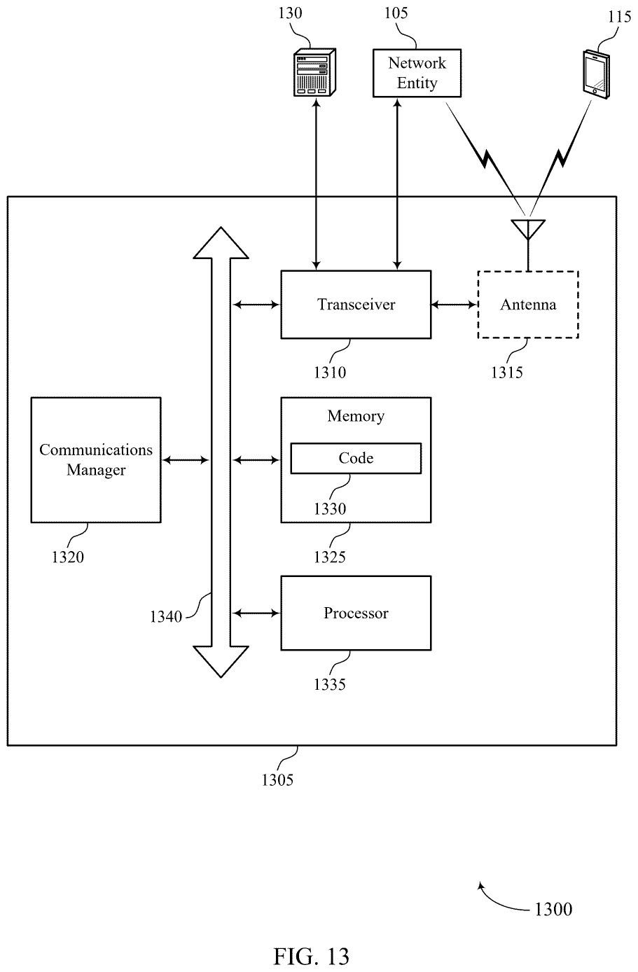

FIG. 13 shows a diagram of a system 1300 including a device 1305 that supports wake-up signal configurations in wireless communications in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting wake-up signal configurations in wireless communications). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting, to a UE, configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state associated with activation of a first receiver at the UE to an active state associated with activation of a second receiver at the UE. The communications manager 1320 is capable of, configured to, or operable to support a means for outputting, to the UE, the wake-up signal in accordance with the configuration information, where the wake-up signal includes control information that is based on the quantity of chips per OFDM symbol.

By including or configuring the communications manager 1320 in accordance with examples as described herein, the device 1305 may support techniques for wake-up signal configurations that provide for reduced latency, improved user experience related to reduced processing, reduced power consumption, more efficient utilization of communication resources, improved coordination between devices, and longer battery life.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of wake-up signal configurations in wireless communications as described herein, or the at least one processor 1335 and the at least one memory 1325 may be otherwise configured to, individually or collectively, perform or support such operations.

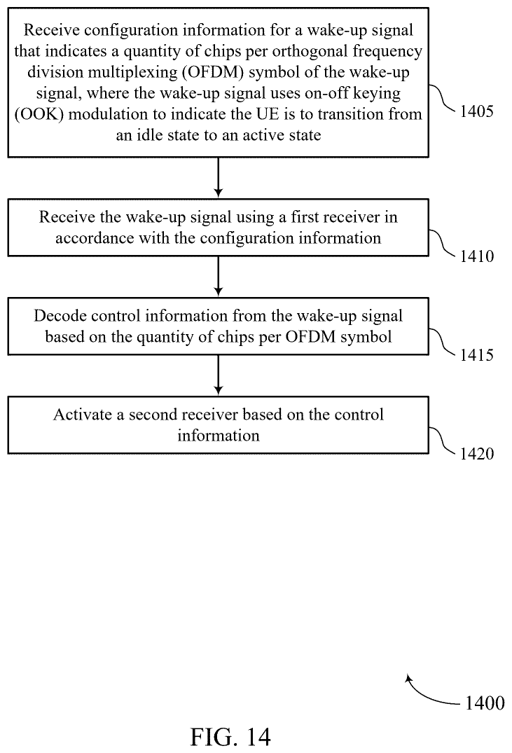

FIG. 14 shows a flowchart illustrating a method 1400 that supports wake-up signal configurations in wireless communications in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state to an active state. The operations of 1405 may be performed in accordance with examples as disclosed herein. In some examples, aspects of the operations of 1405 may be performed by a configuration component 825 as described with reference to FIG. 8.

At 1410, the method may include receiving the wake-up signal using a first receiver in accordance with the configuration information. The operations of 1410 may be performed in accordance with examples as disclosed herein. In some examples, aspects of the operations of 1410 may be performed by an LP receiver 830 as described with reference to FIG. 8.

At 1415, the method may include decoding control information from the wake-up signal based on the quantity of chips per OFDM symbol. The operations of 1415 may be performed in accordance with examples as disclosed herein. In some examples, aspects of the operations of 1415 may be performed by a WUS component 835 as described with reference to FIG. 8.

At 1420, the method may include activating a second receiver based on the control information. The operations of 1420 may be performed in accordance with examples as disclosed herein. In some examples, aspects of the operations of 1420 may be performed by a WUS component 835 as described with reference to FIG. 8.

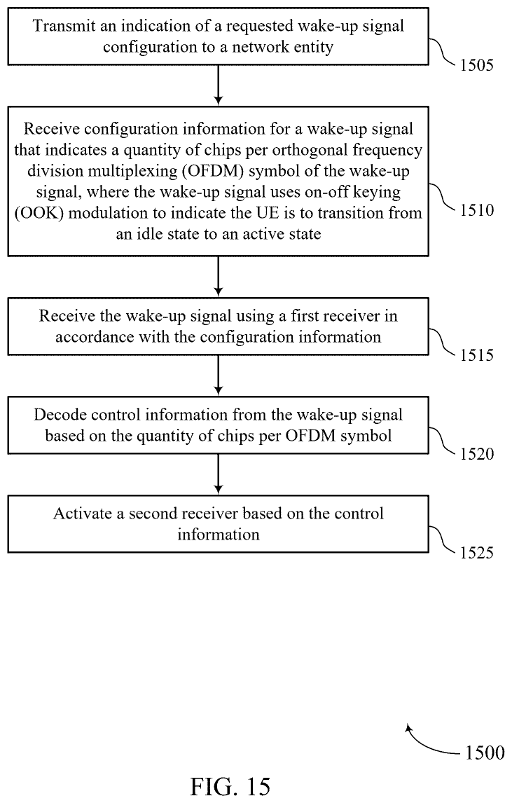

FIG. 15 shows a flowchart illustrating a method 1500 that supports wake-up signal configurations in wireless communications in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting an indication of a requested wake-up signal configuration to a network entity. The operations of 1505 may be performed in accordance with examples as disclosed herein. In some examples, aspects of the operations of 1505 may be performed by a configuration component 825 as described with reference to FIG. 8.

At 1510, the method may include receiving configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state to an active state. The operations of 1510 may be performed in accordance with examples as disclosed herein. In some examples, aspects of the operations of 1510 may be performed by a configuration component 825 as described with reference to FIG. 8.

At 1515, the method may include receiving the wake-up signal using a first receiver in accordance with the configuration information. The operations of 1515 may be performed in accordance with examples as disclosed herein. In some examples, aspects of the operations of 1515 may be performed by an LP receiver 830 as described with reference to FIG. 8.

At 1520, the method may include decoding control information from the wake-up signal based on the quantity of chips per OFDM symbol. The operations of 1520 may be performed in accordance with examples as disclosed herein. In some examples, aspects of the operations of 1520 may be performed by a WUS component 835 as described with reference to FIG. 8.

At 1525, the method may include activating a second receiver based on the control information. The operations of 1525 may be performed in accordance with examples as disclosed herein. In some examples, aspects of the operations of 1525 may be performed by a WUS component 835 as described with reference to FIG. 8.

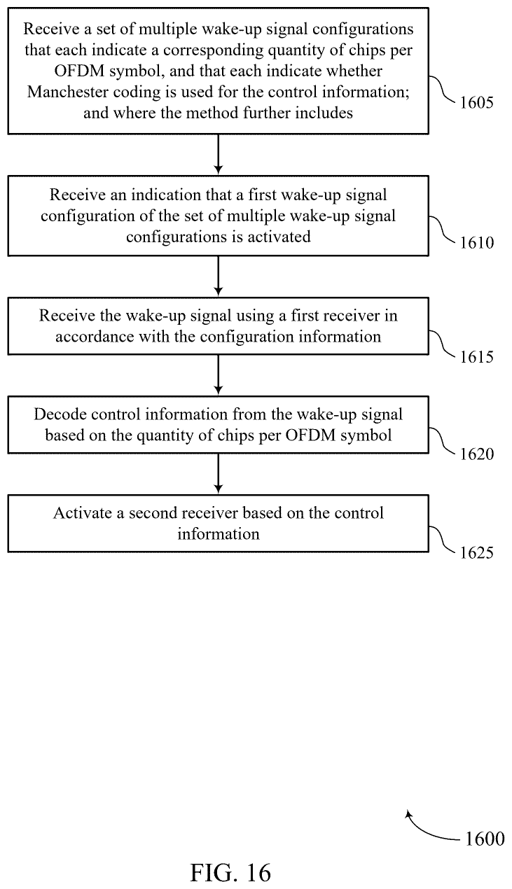

FIG. 16 shows a flowchart illustrating a method 1600 that supports wake-up signal configurations in wireless communications in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving a set of multiple wake-up signal configurations that each indicate a corresponding quantity of chips per OFDM symbol, and that each indicate whether Manchester coding is used for the control information; and where the method further includes. The operations of 1605 may be performed in accordance with examples as disclosed herein. In some examples, aspects of the operations of 1605 may be performed by a configuration component 825 as described with reference to FIG. 8.

At 1610, the method may include receiving an indication that a first wake-up signal configuration of the set of multiple wake-up signal configurations is activated. The operations of 1610 may be performed in accordance with examples as disclosed herein. In some examples, aspects of the operations of 1610 may be performed by a configuration component 825 as described with reference to FIG. 8.

At 1615, the method may include receiving the wake-up signal using a first receiver in accordance with the configuration information. The operations of 1615 may be performed in accordance with examples as disclosed herein. In some examples, aspects of the operations of 1615 may be performed by an LP receiver 830 as described with reference to FIG. 8.

At 1620, the method may include decoding control information from the wake-up signal based on the quantity of chips per OFDM symbol. The operations of 1620 may be performed in accordance with examples as disclosed herein. In some examples, aspects of the operations of 1620 may be performed by a WUS component 835 as described with reference to FIG. 8.

At 1625, the method may include activating a second receiver based on the control information. The operations of 1625 may be performed in accordance with examples as disclosed herein. In some examples, aspects of the operations of 1625 may be performed by a WUS component 835 as described with reference to FIG. 8.

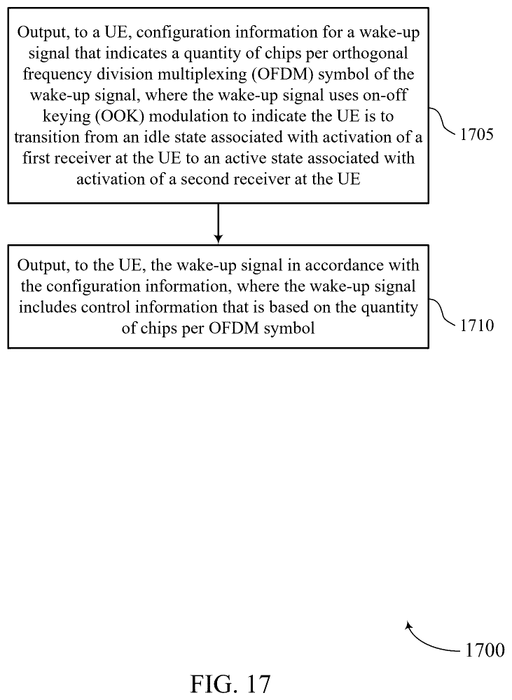

FIG. 17 shows a flowchart illustrating a method 1700 that supports wake-up signal configurations in wireless communications in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting, to a UE, configuration information for a wake-up signal that indicates a quantity of chips per orthogonal frequency division multiplexing (OFDM) symbol of the wake-up signal, where the wake-up signal uses on-off keying (OOK) modulation to indicate the UE is to transition from an idle state associated with activation of a first receiver at the UE to an active state associated with activation of a second receiver at the UE. The operations of 1705 may be performed in accordance with examples as disclosed herein. In some examples, aspects of the operations of 1705 may be performed by a configuration component 1225 as described with reference to FIG. 12.

At 1710, the method may include outputting, to the UE, the wake-up signal in accordance with the configuration information, where the wake-up signal includes control information that is based on the quantity of chips per OFDM symbol. The operations of 1710 may be performed in accordance with examples as disclosed herein. In some examples, aspects of the operations of 1710 may be performed by a WUS component 1230 as described with reference to FIG. 12.

The following provides an overview of aspects of the present disclosure:
Aspect 1: A method for wireless communications at a user equipment, comprising: receiving configuration information for a wake-up signal that indicates a quantity of chips per orthogonal frequency division multiplexing (OFDM) symbol of the wake-up signal, wherein the wake-up signal uses on-off keying (OOK) modulation to indicate the UE is to transition from an idle state to an active state; receiving the wake-up signal using a first receiver in accordance with the configuration information; decoding control information from the wake-up signal based at least in part on the quantity of chips per OFDM symbol; and activating a second receiver based at least in part on the control information.
Aspect 2: The method of aspect 1, wherein the configuration information further indicates whether the wake-up signal uses Manchester coding to encode at least a portion of the control information.
Aspect 3: The method of any of aspects 1 through 2, further comprising:
   transmitting an indication of a requested wake-up signal configuration to a network entity.
Aspect 4: The method of aspect 3, wherein the indication of the requested wake-up signal configuration includes a requested quantity of chips per OFDM symbol, a request for Manchester coding of the control information, a requested configuration of a plurality of wake-up signal configurations, or any combination thereof.
Aspect 5: The method of any of aspects 1 through 4, wherein the receiving configuration information comprises: receiving a plurality of wake-up signal configurations that each indicate a corresponding quantity of chips per OFDM symbol, and that each indicate whether Manchester coding is used for the control information; and wherein the method further comprises: receiving an indication that a first wake-up signal configuration of the plurality of wake-up signal configurations is activated.
Aspect 6: The method of aspect 5, wherein the indication that the first wake-up signal configuration of the plurality of wake-up signal configurations is activated is received in one or more control bits of the control information of the wake-up signal.
Aspect 7: The method of any of aspects 1 through 6, wherein the control information includes a first set of bits that indicate a target UE or UE group ID associated with the wake-up signal, and a second set of bits that indicate one or more parameters for activating the second receiver, and wherein a quantity of bits of the first set of bits or the second set of bits is based at least in part on the quantity of chips per OFDM symbol.
Aspect 8: The method of any of aspects 1 through 7, wherein the control information includes one or more of a wake-up or no-wake-up indication, an indication to transmit an uplink reference signal, an indication to transmit a measurement report, an indication to start or stop an inactivity timer, or any combination thereof.
Aspect 9: The method of any of aspects 1 through 8, wherein a quantity of OOK symbols transmitted via the wake-up signal is based at least in part on the quantity of chips per OFDM symbol, or the quantity of chips per OFDM symbol is based at least in part on the quantity of OOK symbols transmitted via the wake-up signal.
Aspect 10: The method of any of aspects 1 through 9, wherein an OFDM sequence is overlaid with on-duration chips of the wake-up signal, and the OFDM sequence is selected based at least in part on the quantity of chips per OFDM symbol.
Aspect 11: The method of any of aspects 1 through 10, wherein the quantity of chips per OFDM symbol of the wake-up signal is different than a quantity of chips per OFDM symbol of a low-power synchronization signal that is transmitted by a network entity.
Aspect 12: A method for wireless communications at a network entity, comprising: outputting, to a UE, configuration information for a wake-up signal that indicates a quantity of chips per orthogonal frequency division multiplexing (OFDM) symbol of the wake-up signal, wherein the wake-up signal uses on-off keying (OOK) modulation to indicate the UE is to transition from an idle state associated with activation of a first receiver at the UE to an active state associated with activation of a second receiver at the UE; and outputting, to the UE, the wake-up signal in accordance with the configuration information, wherein the wake-up signal includes control information that is based at least in part on the quantity of chips per OFDM symbol.
Aspect 13: The method of aspect 12, wherein the configuration information further indicates whether the wake-up signal uses Manchester coding to encode at least a portion of the control information.
Aspect 14: The method of any of aspects 12 through 13, further comprising: obtaining, from the UE, an indication of a requested wake-up signal configuration.
Aspect 15: The method of aspect 14, wherein the indication of the requested wake-up signal configuration includes a requested quantity of chips per OFDM symbol, a request for Manchester coding of the control information, a requested configuration of a plurality of wake-up signal configurations, or any combination thereof.
Aspect 16: The method of any of aspects 12 through 15, wherein the outputting configuration information comprises: outputting a plurality of wake-up signal configurations that each indicate a corresponding quantity of chips per OFDM symbol, and that each indicate whether Manchester coding is used for the control information; and wherein the method further comprises: outputting an indication that a first wake-up signal configuration of the plurality of wake-up signal configurations is activated.
Aspect 17: The method of aspect 16, wherein the indication that the first wake-up signal configuration of the plurality of wake-up signal configurations is activated is provided in one or more control bits of the control information of the wake-up signal.
Aspect 18: The method of any of aspects 12 through 17, wherein the control information includes a first set of bits that indicate a target UE or UE group ID associated with the wake-up signal, and a second set of bits that indicate one or more parameters for activating the second receiver, and wherein a quantity of bits of the first set of bits or the second set of bits is based at least in part on the quantity of chips per OFDM symbol.
Aspect 19: The method of any of aspects 12 through 18, wherein the control information includes one or more of a wake-up or no-wake-up indication, an indication to transmit an uplink reference signal, an indication to transmit a measurement report, an indication to start or stop an inactivity timer, or any combination thereof.
Aspect 20: The method of any of aspects 12 through 19, wherein a quantity of OOK symbols transmitted via the wake-up signal is based at least in part on the quantity of chips per OFDM symbol, or the quantity of chips per OFDM symbol is based at least in part on the quantity of OOK symbols transmitted via the wake-up signal.
Aspect 21: The method of any of aspects 12 through 20, wherein an OFDM sequence is overlaid with on-duration chips of the wake-up signal, and the OFDM sequence is selected based at least in part on the quantity of chips per OFDM symbol.
Aspect 22: The method of any of aspects 12 through 21, wherein the quantity of chips per OFDM symbol of the wake-up signal is different than a quantity of chips per OFDM symbol of a low-power synchronization signal that is transmitted by a network entity.
Aspect 23: A user equipment for wireless communications, comprising one or more memories storing processor-executable code, and one or more processors coupled with the one or more memories and individually or collectively operable to execute the code to cause the user equipment to perform a method of any of aspects 1 through 11.
Aspect 24: A user equipment for wireless communications, comprising at least one means for performing a method of any of aspects 1 through 11.
Aspect 25: A non-transitory computer-readable medium storing code for wireless communications, the code comprising instructions executable by one or more processors to perform a method of any of aspects 1 through 11.
Aspect 26: A network entity for wireless communications, comprising one or more memories storing processor-executable code, and one or more processors coupled with the one or more memories and individually or collectively operable to execute the code to cause the network entity to perform a method of any of aspects 12 through 22.
Aspect 27: A network entity for wireless communications, comprising at least one means for performing a method of any of aspects 12 through 22.
Aspect 28: A non-transitory computer-readable medium storing code for wireless communications, the code comprising instructions executable by one or more processors to perform a method of any of aspects 12 through 22.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment, comprising:
one or more memories storing processor-executable code; and
one or more processors coupled with the one or more memories and individually or collectively operable to execute the code to cause the user equipment to:
receive configuration information for a wake-up signal that indicates a quantity of chips per orthogonal frequency division multiplexing (OFDM) symbol of the wake-up signal, wherein the wake-up signal uses on-off keying (OOK) modulation to indicate the user equipment is to transition from an idle state to an active state;
receive the wake-up signal using a first receiver in accordance with the configuration information;
decode control information from the wake-up signal based at least in part on the quantity of chips per OFDM symbol; and
activate a second receiver based at least in part on the control information.

2. The user equipment of claim 1, wherein the control information includes an identifier of the user equipment.

3. The user equipment of claim 1, wherein the quantity of chips per OFDM symbol of the wake-up signal is different than a quantity of chips per OFDM symbol of a low-power synchronization signal that is transmitted by a network entity.

4. The user equipment of claim 1, wherein the configuration information further indicates whether the wake-up signal uses Manchester coding to encode at least a portion of the control information.

5. The user equipment of claim 1, wherein the one or more processors are individually or collectively further operable to execute the code to cause the user equipment to:
transmit an indication of a requested wake-up signal configuration to a network entity.

6. The user equipment of claim 5, wherein the indication of the requested wake-up signal configuration includes a requested quantity of chips per OFDM symbol, a request for Manchester coding of the control information, a requested configuration of a plurality of wake-up signal configurations, or any combination thereof.

7. The user equipment of claim 1, wherein, to receive the configuration information, the one or more processors are individually or collectively operable to execute the code to cause the user equipment to:
receive a plurality of wake-up signal configurations that each indicate a corresponding quantity of chips per OFDM symbol, and that each indicate whether Manchester coding is used for the control information; and wherein the one or more processors are individually or collectively operable to execute the code to further cause the user equipment to:
receive an indication that a first wake-up signal configuration of the plurality of wake-up signal configurations is activated.

8. The user equipment of claim 7, wherein the indication that the first wake-up signal configuration of the plurality of wake-up signal configurations is activated is received in one or more control bits of the control information of the wake-up signal.

9. The user equipment of claim 1, wherein the control information includes a first set of bits that indicate a target UE or UE group ID associated with the wake-up signal, and a second set of bits that indicate one or more parameters for activating the second receiver, and wherein a quantity of bits of the first set of bits or the second set of bits is based at least in part on the quantity of chips per OFDM symbol.

10. The user equipment of claim 1, wherein the control information includes one or more of a wake-up or no-wake-up indication, an indication to transmit an uplink reference signal, an indication to transmit a measurement report, an indication to start or stop an inactivity timer, or any combination thereof.

11. The user equipment of claim 1, wherein a quantity of OOK symbols transmitted via the wake-up signal is based at least in part on the quantity of chips per OFDM symbol, or the quantity of chips per OFDM symbol is based at least in part on the quantity of OOK symbols transmitted via the wake-up signal.

12. The user equipment of claim 1, wherein an OFDM sequence is overlaid with on-duration chips of the wake-up signal, and the OFDM sequence is selected based at least in part on the quantity of chips per OFDM symbol.

13. A method for wireless communications at a user equipment, comprising:
receiving configuration information for a wake-up signal that indicates a quantity of chips per orthogonal frequency division multiplexing (OFDM) symbol of the wake-up signal, wherein the wake-up signal uses on-off keying (OOK) modulation to indicate the user equipment is to transition from an idle state to an active state;
receiving the wake-up signal using a first receiver in accordance with the configuration information;
decoding control information from the wake-up signal based at least in part on the quantity of chips per OFDM symbol; and
activating a second receiver based at least in part on the control information.

14. The method of claim 13, further comprising:
transmitting an indication of a requested wake-up signal configuration to a network entity.

15. The method of claim 13, wherein the receiving the configuration information comprises:
receiving a plurality of wake-up signal configurations that each indicate a corresponding quantity of chips per OFDM symbol, and that each indicate whether Manchester coding is used for the control information; and wherein the method further comprises:
receiving an indication that a first wake-up signal configuration of the plurality of wake-up signal configurations is activated.

16. The method of claim 13, wherein the control information includes a first set of bits that indicate a target UE or UE group ID associated with the wake-up signal, and a second set of bits that indicate one or more parameters for activating the second receiver, and wherein a quantity of bits of the first set of bits or the second set of bits is based at least in part on the quantity of chips per OFDM symbol.

17. The method of claim 13, wherein the control information includes one or more of a wake-up or no-wake-up indication, an indication to transmit an uplink reference signal, an indication to transmit a measurement report, an indication to start or stop an inactivity timer, or any combination thereof.

18. The method of claim 13, wherein a quantity of OOK symbols transmitted via the wake-up signal is based at least in part on the quantity of chips per OFDM symbol, or the quantity of chips per OFDM symbol is based at least in part on the quantity of OOK symbols transmitted via the wake-up signal.

19. A non-transitory computer-readable medium storing code for wireless communications, the code comprising instructions executable by one or more processors to:
receive, at a user equipment, configuration information for a wake-up signal that indicates a quantity of chips per orthogonal frequency division multiplexing (OFDM) symbol of the wake-up signal, wherein the wake-up signal uses on-off keying (OOK) modulation to indicate the user equipment is to transition from an idle state to an active state;
receive the wake-up signal using a first receiver in accordance with the configuration information;
decode control information from the wake-up signal based at least in part on the quantity of chips per OFDM symbol; and
activate a second receiver based at least in part on the control information.

20. The non-transitory computer-readable medium of claim 19, wherein the instructions to receive configuration information are executable by the one or more processors to:
receive a plurality of wake-up signal configurations that each indicate a corresponding quantity of chips per OFDM symbol, and that each indicate whether Manchester coding is used for the control information; and
receive an indication that a first wake-up signal configuration of the plurality of wake-up signal configurations is activated.
